(19) United States
(12) Patent Application Publication
(10) Pub. No.: US 2017/0220683 A1
(43) Pub. Date: Aug. 3, 2017

(54) SHADOW ELEMENTS

(71) Applicant: Hewlett Packard Enterprise Development LP, Houston, TX (US)

(72) Inventors: Luis Miguel VAQUERO GONZALEZ, Bristol (GB); Suksant SAE LOR, Bristol (GB)

(21) Appl. No.: 15/500,871

(22) PCT Filed: Jul. 31, 2014
(86) PCT No.: PCT/US2014/049075

§ 371 Date: Jan. 31, 2017

(51) Int. Cl. G06F 17/30

(52) U.S. Cl. CPC G06F 17/30864; G06F 17/30958; G06F 17/30554

(57) ABSTRACT

Shadow elements can in an example embodiment include determining a base similarity of an element included in a graph, selecting an anonymous characteristic of a shadow element satisfying the base similarity, substituting a characteristic of the element with the anonymous characteristic, and returning the anonymous characteristic instead of the substituted characteristic in response to a query of the element included in the graph.

### BACKGROUND

A graph may be used in a variety of contexts to convey information included the graph and/or enable additional information (e.g., a motif) to be derived from the information in the graph. Information in a graph may be confidential, private (e.g., personal information such as names, addresses, etc.), protected by law, and/or otherwise sensitive.

### BRIEF DESCRIPTION OF THE DRAWINGS

FIG. 1 illustrates a diagram of an example of a system for shadow elements according to the present disclosure.

FIG. 2 illustrates a diagram of an example computing device according to the present disclosure.

FIG. 3 illustrates an example of an environment in which various example processes can be implemented for shadow elements according to the present disclosure.

FIG. 4 illustrates an example of a graph environment in which various example processes can be implemented for shadow elements according to the present disclosure.

FIG. 5 illustrates a flow diagram of an example of a method for shadow elements according to the present disclosure.

### DETAILED DESCRIPTION

A graph can be used in a variety of contexts to convey information included the graph and/or enable additional information (e.g., a motif) to be derived from the information in the graph. However, information in a graph and/or information derived from a graph may be sensitive (e.g., confidential, private, and/or protected by law, etc.). As such, it can be desirable to maintain anonymity (e.g., a condition of being anonymous) of such sensitive information, for example, when conveying and/or utilizing information included in a graph and/or conveying and/or utilizing information derived from a graph.

Some approaches attempting to maintain anonymity of information included in and/or derived from a graph may rely upon modification of the graph (e.g., adding and/or removing data points) and/or various ways of masking of the information in the graph. However, such approaches may be ineffective, costly (e.g., time consuming), and/or again may rely on modification of the graph (e.g., addition and/or removal of edges and/or nodes of a graph) that in may in turn alter properties of the graph (e.g., statistical and/or spectral properties) which may lead to alteration of information capable of being derived from the graph, among other difficulties.

In contrast, examples of the present disclosure include methods, systems, and computer-readable media with executable instructions stored thereon for shadow elements. Shadow elements, for example, can include determining a base similarity of an element included in a graph, selecting an anonymous characteristic of a shadow element satisfying the base similarity, substituting a characteristic of the element with the anonymous characteristic, and returning the anonymous characteristic instead of the substituted characteristic in response to a query of the element included in the graph. Advantageously, shadow elements can facilitate maintaining properties of a graph (e.g., statistical properties and/or statistical relationships of a respective plurality of elements of a motif), as described herein, and/or facilitate providing a desired degree of anonymity of a graph, among other advantages.

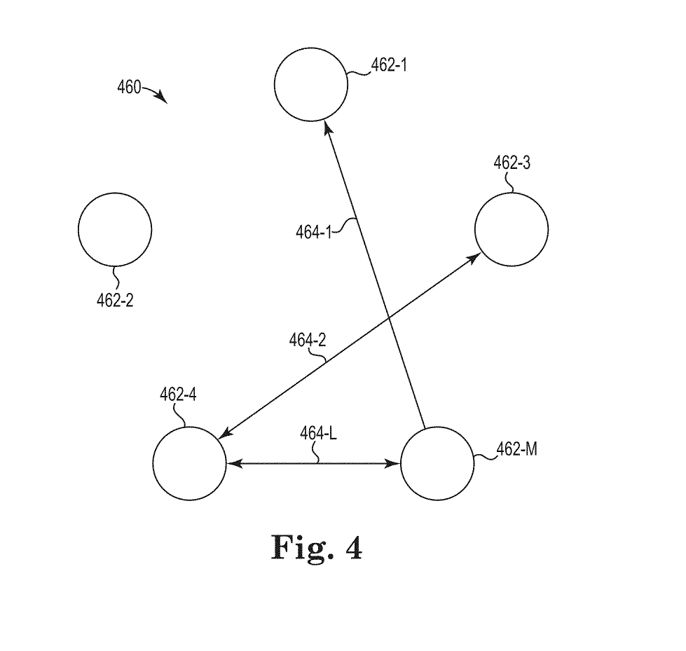

A graph refers to a mathematical representation of a collection of nodes, among other possible information (e.g., edges, etc.). For example, a graph can be defined mathematically as including ordered and/or unordered pairs of nodes and edges. A graph can be undirected graph (e.g., a graph having undirected edges) or a directed graph (e.g., a graph having directed edges), such as the graph detailed herein with respect to FIG. 4. Examples of graphs include bipartite graphs, acyclic graphs (e.g., directed acyclic graphs), and/or planar graphs, among other types of graphs.

A graph can include a motif(s). A motif refers to a particular pattern (e.g., a visual pattern including at least one edge between two nodes) such as a reoccurring and/or a statistically significant pattern in a graph. Motifs can be detected, for example, by various methods including those described herein. Examples of motifs include a social hierarchy (e.g., a social network), an organizational structure, a data structure, a topology of an enterprise system, a topology of a computer network, among other motifs capable of being included in a graph. Motifs can also result from the application of transformation (e.g. machine learning) techniques and have no real mapping to real world entities. For instance, the application of a PCA or the mapping of a Nth order function to a Mth order (where N>>M) may result in the creation of motifs that are not easily understandable by the “naked” human eye, but are still useful to our method.

A motif can include a plurality of elements such as node elements (i.e., nodes) and edge elements (i.e., edges). Examples of nodes include people, configuration items including, but are not limited to computing devices, computer software, information systems, computer hardware, and processes related thereto, and/or data points, etc. Edges refer to a representation of a connection between two nodes in a graph. That is, a connection (e.g., between a shared characteristic and/or a shared category of the two nodes) can be represented by an edge connecting two distinct nodes included in a particular motif of a graph.

A shadow element refers to an element (e.g., an selected from a motif satisfying a base similarity and/or a synthetic element) satisfying a base similarity of an element included in a graph, having at least one characteristic that can be substituted as an anonymous characteristic for a characteristic of the element included in the graph. For example, a shadow element can be an element that satisfies both a base similarity of a motif and a base similarity of an element included in a graph.

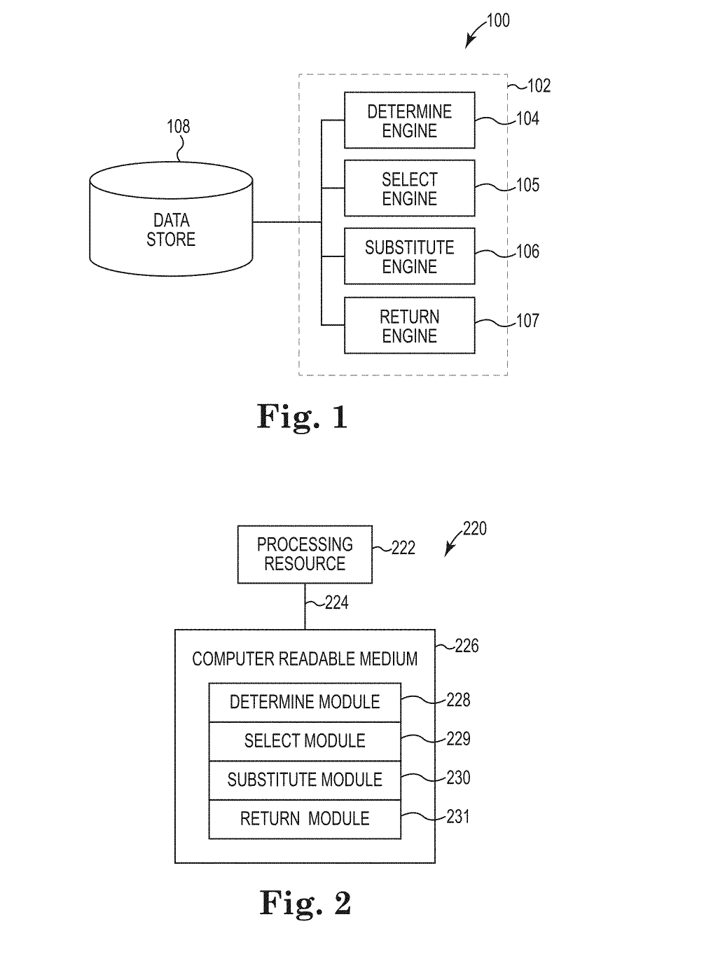

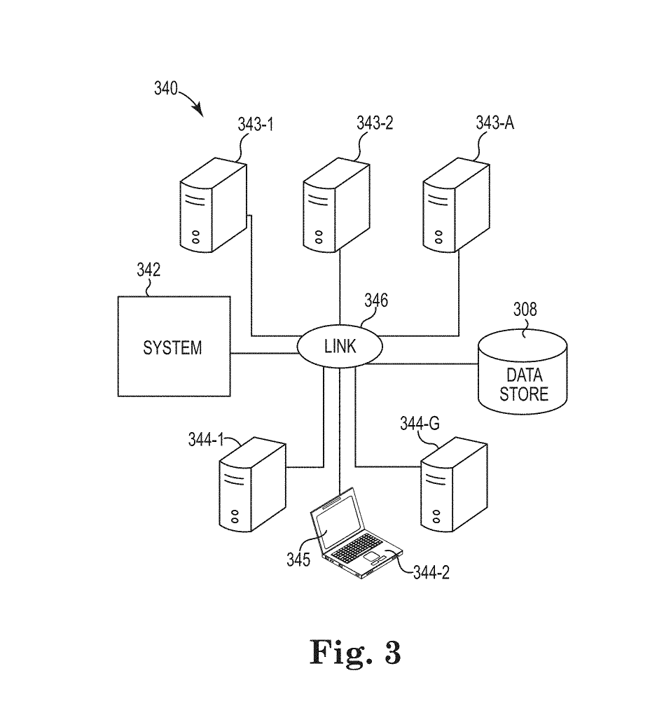

FIG. 1 illustrates a diagram of an example of a system 100 for shadow elements according to the present disclosure. The system 100 can include a data store 108 (e.g., analogous to data store 308 as referenced in FIG. 3), a shadow element system 102, and/or a number of engines. The shadow element system 102 can be in communication with the data store 108. The shadow element system 102 can include a number of engines (e.g., a determine engine 104, a select engine 105, a substitute engine 106, a return engine 107, etc.). The shadow element system 102 can include additional or fewer engines than illustrated to perform the various functions described herein.

The number of engines can include a combination of hardware and programming to perform a number of functions described herein (e.g., the determine engine 104 determines a base similarity of an element included in a graph, etc.). Each of the engines can include hardware or a combination of hardware and programming designated or designed to execute a module (e.g., a particular module). The programming can include instructions (e.g., software, firmware, etc.) stored in a memory resource (e.g., computer-readable medium) as well as a hard-wired program (e.g., logic).

A motif and/or a plurality of motifs can be extracted by an extraction engine (not shown) from a graph. Such extraction can include constructing a plurality of sub-graphs, determining the significance of the plurality of sub-graphs (e.g., significance based on frequency of occurrence of elements such as a frequency above a frequency threshold can be deemed statistically significant) and/or characteristics, etc., significance based on a standard score (Zscore) (e.g., a Zscore larger than 1 can be deemed as statistically significant), a probability value (Pvalue), naive Bayes, or other measure of randomly occurrence of elements and/or characteristics, among other ways to extract a motif. Graphs, extracted motifs and/or extracted elements can be stored in a data store, such as those described herein, which can facilitate selection of anonymous characteristic of a shadow element (e.g., an extracted element) satisfying a base similarity, among other aspects of shadow elements as described herein.

The extraction engine (not shown) can extract, from a motif, such as a motif included in a plurality of motifs, characteristics of each of a plurality of elements included in the motif. Put another way, respective characteristic can be extracted for each of a plurality of nodes and/or a plurality of edges included in each of the plurality of extracted motifs.

The determine engine 104 can determine a base similarity of an element included in a graph. For example, the determine engine 104 can determine a base similarity of an element included in a graph. For example, the determine engine 104 can determine a base similarity of a plurality of elements included in a motif extracted from a graph. In this manner, a base similarity for a single element (e.g., an isolated node and/or a single edge) can be determined and/or a base similarity common to a plurality of elements (e.g., a plurality of nodes and/or edges) can be determined.

A base similarity refers to a value (e.g., a numerical value and/or percentage), a threshold, a rule-based system, a user provided input, a function and/or other basis that a particular shadow element can either satisfy or not satisfy. For example, a base similarity can be a value (e.g., a threshold value of 0.9) and/or a function which is capable of producing a value, among other possibilities including user-provided and/or learned (e.g. learned base on fuzzy art-map learned rules, etc.) base similarities, among others possible ways to evaluate entity similarity.

A base similarity can be determined in response to extraction of a motif and/or an element (e.g., a plurality of elements) included in a motif. Similarly, in some examples, a default base similarity can be determined (e.g., set automatically in response to extraction of a motif). A base similarity (e.g., a numerical value such as 0.8) can be based on at least one of a plurality of characteristics of an element included in the graph and/or a desired end use (e.g., an application) of anonymous characteristics, among other possible considerations. A desired end use refers to a consumer, an application (e.g., various types of mapping and statistical analysis), a business purpose (e.g., marketing, analysis of a topology associated with the information in the graph), among other considerations tied to various desired end uses.

Characteristics (e.g., Chris, Montana and/or a particular geographic address, single and/or friends with Mike, etc.) refer to information included in categories, as described herein of an element. Categories (e.g., name, location, relationship status, a node degree, a total number of outgoing edges from the node, etc.) of information can be included in different motifs. Relevance of a category and/or an underlying characteristic can depend upon a given motif of a plurality of motifs included in a graph. For example, while a name can be relevant to a social motif (e.g., a social network motif) the name may not be relevant (e.g., included in) to a location motif (e.g., a geographic topology motif).

Notably, connections, even when substituting one or both of the elements in a connection, can be maintained by way of correlation of a characteristic(s) in a given category of an element to characteristic(s) of a shadow element in the category. An edge and/or a shadow edge can represent such a connection. Maintaining such connections can advantageously enable maintaining of properties (e.g., statistical and/or spectral properties) of a graph, maintaining properties (statistical and/or spectral properties) of each of a plurality of elements included in a motif of the graph, and/or to facilitate shadow elements, as described herein. Put another way, while underlying characteristics may vary (e.g., from a node to a shadow node and/or from a shadow node to another shadow node) the categories, statistical, and spectral properties remain for a shadowed element and a particular motif including the shadowed element.

An element in a graph can be identified by use of identifying information. Identifying information can be obtained from an extracted element. For example, an anonymous identifier (e.g., an anonymous numerical identifier such as 484850), among other identifying information, can identify a particular element (e.g., node) of a plurality of elements included in a graph and/or a motif of the graph. Identifying information, such as an anonymous identifier, can further promote anonymizing graphs and/or information included therein.

The select engine 105 can select an anonymous characteristic of a shadow element satisfying a base similarity. That is, the select engine 105 can select anonymous characteristics of a shadow element satisfying a base similarity as determined by the determine engine 104. That is, the select engine 105 selects anonymous characteristics from shadow elements. Shadow elements can be different elements (different than an substituted element in a motif) included in a motif (e.g., an element included in another motif that satisfies a base similarity) and/or synthetic elements that satisfy a base similarity.

For instance, the select engine 105 can select anonymous characteristics of a shadow element that satisfy (e.g., each satisfy) a base similarity and/or not select anonymous characteristics of elements that do not satisfy the base similarity. For example, selected anonymous characteristics, selected by the select engine 105, can include anonymous characteristic of a synthetic element. A synthetic element can, for example, be selected when anonymous characteristics of another element in the graph are not available (e.g., when another element included in the graph does not satisfy a base similarity).

In some examples, a base similarity can enable selection of shadow elements included in a motif (e.g., a motif satisfying a base similarity threshold) and/or selection of synthetic shadow elements, such as those described herein, as suitable shadow elements satisfying a base similarity. In some examples, a default base similarity can enable selection of a particular type of element (e.g., synthetic elements) of a number of shadow elements.

Select engine 105 can select a motif that satisfies a base similarity. For example, an extracted motif, of a plurality of extracted motifs, can be selected. An element, within the selected motif, can be selected that satisfies a base similarity (a base similarity that is that same or different than a base similarity used in selection of the motif).

A substitute engine 106 can substitute a characteristic of an element included in a graph with the anonymous characteristic. For example, the substitute engine 106 can substitute characteristics of the element selected by the select engine 105 to create a plurality of shadow elements (e.g., shadow nodes). That is, in some examples, the substitute engine 106 can substitute a characteristic(s) of a node included in a graph with an anonymous characteristic(s) to create a shadow node. Similarly, the substitute engine 106 can substitute a characteristic(s) of an edge included in a graph with an anonymous characteristic(s) to create a shadow edge. In either case, anonymity of the element (e.g., the shadowed element) is maintained by ensuring that at least one of the characteristics of the shadowed node is different than at least one of the anonymous characteristics of a shadow element and/or that the shadow element is from a different motif than the substituted element.

A total number of characteristics that are different may vary depending upon a base similarity of a particular element. For example, an element having a comparatively higher base similarity (e.g., a base similarity threshold of 0.9) may have comparatively less characteristics (e.g., 1 characteristics that are different) that differ from a shadow element that satisfies the base similarity than another element having a comparatively lower base similarity (e.g., a base similarity threshold of 0.5) may have comparatively more characteristics (e.g., 3 characteristics that are different) that differ from a shadow element that satisfies the comparatively lower base similarity.

Substitution by the substitute engine 106 can include correlation of each of the substituted characteristics with a corresponding characteristic in the anonymous characteristics. For example, statistical properties of a substituted characteristic in a particular motif are preserved through correlation of the substituted characteristic with an anonymous characteristic having the same statistical properties. In this manner, statistical properties of each of the substituted characteristics can be preserved through correlation. Notably, properties of a graph, a motif (e.g., a plurality of elements included in a motif), and/or an individual element (e.g., an isolated node) can be maintained, as described herein. Examples of statistical properties of a graph can include an average node degree of a plurality of nodes in the motif, a total number of incoming edges, a total number of unidirectional edges (e.g., a total number of outgoing edges directed away from a node(s) and/or a total number of incoming edges directed towards a node(s)) and/or a total number of bi-direction edges, among others.

The substitute engine 106 can substitute a node included in a motif with a shadow node (a shadow node satisfying a base similarity threshold) from a plurality of shadow nodes (e.g., a plurality of shadow nodes from at least one motif that satisfies a base similarity threshold). Substitution with another node included in the motif can include substitution with another node in the motif that has statistically significant characteristics that are identical to those of the substituted node. For example, if the substituted node is a two degree node (having two edges) than a shadow node can be a two degree node. Put another way, while the underlying characteristics may or may not be identical with regard to a shadowed element and a shadow element, the statistical characteristics are identical.

In some instances when selecting shadow elements and/or substituting shadow elements, such as instances having a comparatively low total number elements (e.g., nodes) included an a particular graph and/or motif and/or when a comparatively large total number of shadow elements is desired (e.g., to satisfy a comparatively high degree of anonymity) it may be desirable to include synthetic elements. For example, when a desired degree of anonymity corresponding to a total number of nodes exceeds a total number of nodes included in a graph that satisfies a base similarity it may be desirable to include a synthetic node(s) to achieve the total number of nodes corresponding to the desired degree of anonymity. Similarly, it may be desirable to include synthetic elements in the event of returning respective characteristics of each shadow element of a plurality of shadow elements. For example, if a node having a total of 1000 shadow nodes is queried a 1000 times it may be desirable to include additional shadow nodes in the form of different nodes from a graph satisfying a base similarity and/or adding synthetic elements

Synthetic elements refer to elements other than those included in a motif and/or graph when the motif is extracted and/or when the graph is first constructed. Synthetic elements (e.g., synthetic nodes and/or synthetic edges) can be used in combination with and/or or in place of an element in a particular motif and/or graph.

The return engine 107 can returns the anonymous characteristic instead of the substituted characteristic in response to a query of the element included in the graph. Return of the respective anonymous characteristic(s) of a shadow element can include causing a display of the respective anonymous characteristic, for example, via a display of a client device, as described herein, and/or otherwise causing the returns respective anonymous characteristics of a shadow element in response a query of the element. Moreover, the return engine 107 can, for example, in response to another query of the element included in the graph return a respective anonymous characteristic of a different shadow element included in a plurality of shadow elements. Notably, anonymous characteristics of only a single shadow element for a particular shadowed element is returned (e.g., displayed) at a given time.

Such returns of a shadow elements in response to a query can occur automatically (e.g., without a user interaction). For example, a query of a node in a graph can return a corresponding shadow node and/or a query of an edge in a graph can return a corresponding shadow edge. A particular shadow element of a plurality of shadow elements can be returned based on a predetermined order (e.g., incremental) and/or randomized order from shadow elements not previously returned. In this manner, anonymity of the element included in the graph can be maintained (e.g., the substituted characteristics are not returned in response to a query and/or subsequent queries of the node).

FIG. 2 illustrates a diagram of an example of a computing device for shadow elements according to the present disclosure. The computing device 220 can utilize software, hardware, firmware, and/or logic to perform a number of functions described herein.

For example, the computing device 220 can be a combination of hardware and instructions for shadow elements. The hardware, for example can include a processing resource 222 and/or a memory resource 226 (e.g., computer-readable medium (CRM), data store, etc.) A processing resource 222, as used herein, can include a number of processors capable of executing instructions stored by a memory resource 226. Processing resource 222 can be integrated in a single device or distributed across multiple devices (e.g., multiple servers). The instructions (e.g., computer-readable instructions (CRI)) can include instructions stored on the memory resource 226 and executable by the processing resource 222 to implement a desired function (e.g., substitute characteristics of each of the plurality of elements with the anonymous characteristics to create a plurality of shadow elements).

The memory resource 226 can be in communication with a processing resource 222. A memory resource 226, as used herein, can include a number of memory components capable of storing instructions that can be executed by processing resource 222. Such memory resource 226 can be a non-transitory CRM. Memory resource 226 can be integrated in a single device or distributed across multiple devices. Further, memory resource 226 can be fully or partially integrated in the same device as processing resource 222 or it can be separate but accessible to that device and processing resource 222. Thus, it is noted that the computing device 220 can be implemented on a client device, a collection of client device, a support device, a collection of support devices, and/or on a combination of the client devices and support devices.

The memory resource 226 can be in communication with the processing resource 222 via a communication link (e.g., path) 224. The communication link 224 can be local or remote to a computing device associated with the processing resource 222. Examples of a local communication link 224 can include an electronic bus internal to a computing device where the memory resource 226 is one of volatile, non-volatile, fixed, and/or removable storage medium in communication with the processing resource 222 via the electronic bus.

The memory resource 226 can include a number of modules such as a determine module 228, a select module 229, a substitute module 230, a return module 231, etc. The number of modules 228, 229, 230, 231 can include CRI that when executed by the processing resource 222 can perform a number of functions. The number of modules 228, 229, 230, 231 can be sub-modules of other modules. For example, the determine module 228 and the select module 229 can be sub-modules and/or contained within the same computing device. In another example, the number of modules 228, 229, 230, 231 can comprise individual modules at separate and distinct locations (e.g., CRM, etc.).

Each of the number of modules 228, 229, 230, 231 can include instructions that when executed by the processing resource 222 can function as a corresponding engine, including those as described herein. For example, the determine module 228 can include instructions that when executed by the processing resource 222 can function as the determine engine 104, for instance, to the determine engine determines a base similarity of an element included in a graph and/or determine a base similarity of a plurality of elements included in a motif extracted from a graph.

In some examples, the determine module 228 can include instructions that when executed by the processing resource 222 can automatically (e.g., without human inputs such as those from an information technology administrator) determine a base similarity value of a plurality of elements included in a motif extracted from a graph.

The select module 229 can include instructions that when executed by the processing resource 222 can select anonymous characteristics of a shadow element of a plurality of shadow elements satisfying the base similarity, as described herein. The substitute module 230 can include instructions that when executed by the processing resource 222 can substitute characteristics of each of the plurality of elements with the anonymous characteristics. In some examples, the instructions to select can include instructions to select the anonymous characteristics of the shadow element that is included in a motif satisfying a base similarity. The motif can satisfy a base similarity that is the same or different than a base similarity satisfied by shadow element(s).

In some examples, a maintain module (not shown) can include instructions to maintain statistical properties of the respective plurality of elements of the motif. For instance, statistical properties can be maintained before, during, and after substitution of the respective characteristics of each of the plurality of elements with anonymous characteristics. Advantageously, maintaining statistical properties of each of the shadowed elements can promote maintaining statistical properties of a graph including the shadowed elements, among other advantages.

The return module 231 can include instructions that when executed by the processing resource 222 can return respective anonymous characteristics of the shadow element instead of the substituted characteristics in response to a query of an element of the plurality of elements included in the motif.

In some examples, a remove module (not shown) and/or an add module (not shown) can include instructions directed to isolated nodes. The remove node can, in some examples, include instructions that when executed by the processing resource 222 can remove an isolated node from the graph. The add node can, in some examples, include instructions that when executed by the processing resource 222 can add an isolated node to the graph. Removal or addition of isolated nodes to a graph including an isolated node can comparatively increase anonymity of the isolated node included in the graph and/or the graph itself. For example, each isolated node in a graph can be removed or a plurality of isolated nodes can be added to a graph (e.g., to provide a comparative increase in a total number of isolated nodes included in the graph and/or increase anonymity of the graph).

FIG. 3 illustrates an example of an environment 340 in which various example processes can be implemented for shadow elements according to the present disclosure. The environment 340 is shown to include a system 342 for shadow elements, support devices 343-1, 343-2, . . . , 343-A, client devices 344-1, 344-2, . . . , 344-G, a data store 308, and a link 346.

The system 342 for shadow elements can represent different combinations of hardware or hardware and instructions capable to shadow elements. The system 342 for shadow elements can include a computing device (not shown), for instance, computing device 220 as discussed with respect to FIG. 2. The system 342 can include engines analogous to engines described with respect to FIG. 1. For example, the system 342 can include a determine engine, select engine, a substitute engine, and a return engine, as described herein with respect to FIG. 1, among other engines.

Motifs, shadow elements, among other information, can be viewed using a support device, such as support devices 343-1, . . . , 343-A. Support devices 343-1, . . . , 343-A represent devices that can generate/receive electronic data having browsers and/or other applications to communicate such data and/or facilitate viewing of motifs and/or shadow elements, among other abilities. Examples of support devices 343-1, . . . , 343-A include desktop/laptop computers, mobile phones, and/or servers, among other devices suitable for shadow elements. Similarly, examples of client devices 344-1, . . . , 344-G can include desktop/laptop computers, mobile phones, and/or servers, among other devices suitable for shadow elements.

In various examples, the support devices 343-1, . . . , 343-A and/or data store(s) 308 can be separate and distinct from the client devices 344-1, . . . , 344-G. As described herein, being separate and distinct refers to an environment being physically separate and/or having separate network resources with respect to each other. In this manner, a support device can receive (e.g., remotely receive) a query for a graph, a motif include in a graph, characteristics of an element and/or other information from a client device. However, the present disclosure is not so limited. That is, the support devices, data store(s), and client devices can be at the same location (e.g., included in a common building and/or organization). Regardless, receipt of information (e.g., a web-based query for a graph and/or a query of an element include in a motif) from the client devices 344-1, . . . , 344-G by the support devices 343-1, . . . , 343-A can promote shadow elements, as described herein.

The support devices 343-1, . . . , 343-A and/or the client devices 344-1, . . . , 344-G can include an electronic display such as a GUI 345. A user interface (UI) can include hardware components and/or computer-readable instruction components. For instance, hardware components can include input components (e.g., a mouse, a touch screen, and a keyboard) and/or output components (e.g., a display). An example UI can include a GUI. A GUI can, for example, electronically display an indication representing anonymous characteristics of a shadow element, among other electronic representations.

Link 346 (e.g., a network) represents a cable, wireless, fiber optic, and/or remote connection via a telecommunication link, an infrared link, a radio frequency link, and/or other connectors or systems that provide electronic communication. That is, the link 346 can, for example, include a link to an intranet, the Internet, or a combination of both, among other communication interfaces. The link 346 can also include intermediate proxies, for example, an intermediate proxy server, routers, switches, load balancers, and the like. However, the present disclosure is not so limited. That is, link 346 can represent a physical connection between the support devices 343-1, . . . , 343-A and the client devices 344-1, . . . , 344-G to communicate instructions between the client devices 344-1, . . . , 344-G, the support devices 343-1, . . . , 343-A, and/or the data store 308.

FIG. 4 illustrates an example of a graph environment in which various example processes can be implemented for shadow elements according to the present disclosure.

As illustrated in FIG. 4, an example of a graph 460 can include a plurality of elements including a plurality of shadow nodes 462-1, 462-2, 462-3, 462-4, 462-5, 462-M and a plurality of shadow edges 464-1, 464-2, 464-L. The plurality of shadow nodes 462-1, . . . , 462-M can include isolated shadow nodes such as isolated shadow node 462-2 and/or non-isolated shadow nodes (e.g., shadow nodes having a degree of at least one) such as shadow node 462-1 (having a node degree of one), shadow node 462-3 (having a node degree of one), node 462-4 (having a node degree of two), and shadow node 462-M (having a node degree of two).

The shadow edges 464-1, . . . , 464-L can be non-directional and/or directional shadow edges, as described herein. For example, shadow edge 464-1 illustrates an example of a unidirectional incoming shadow edge and shadow edge 464-2 represents an example of a bi-directional shadow edge. Some or all of the shadow edges 464-1, . . . , 464-L and/or the shadow nodes 462-1, . . . , 462-M can be included in a motif. Notably, the graph displayed in

FIG. 4 illustrating the shadow nodes 462-1, . . . , 462-M and the shadow elements is visually identical to a graph of corresponding nodes and edges that are shadowed to create the nodes 462-1, . . . , 462-M and the shadow elements 464-1, . . . , 464-L due to shadowing the nodes and/or edges without modification of the graph.

While the example graph 460 in FIG. 4 illustrates a particular total number of shadow nodes (e.g., 5 shadow nodes) and a particular total number of shadow edges (3 shadow edges) having particular direction(s), the present disclosure is not so limited. That is, a total number of shadow nodes and/or shadow edges and/or direction(s) of a given node(s) among other possible information can vary in a manner suitable to promote shadow elements, as described herein. Similarly, while each of the nodes and edges illustrated in FIG. 4 represents a shadow node or shadow edge, a total number of nodes in a given graph that are shadowed (i.e., shadow nodes) and/or a total number of edges in the given graph that are shadowed (i.e., shadow edges) can include some or all nodes and/or edges included a given graph.

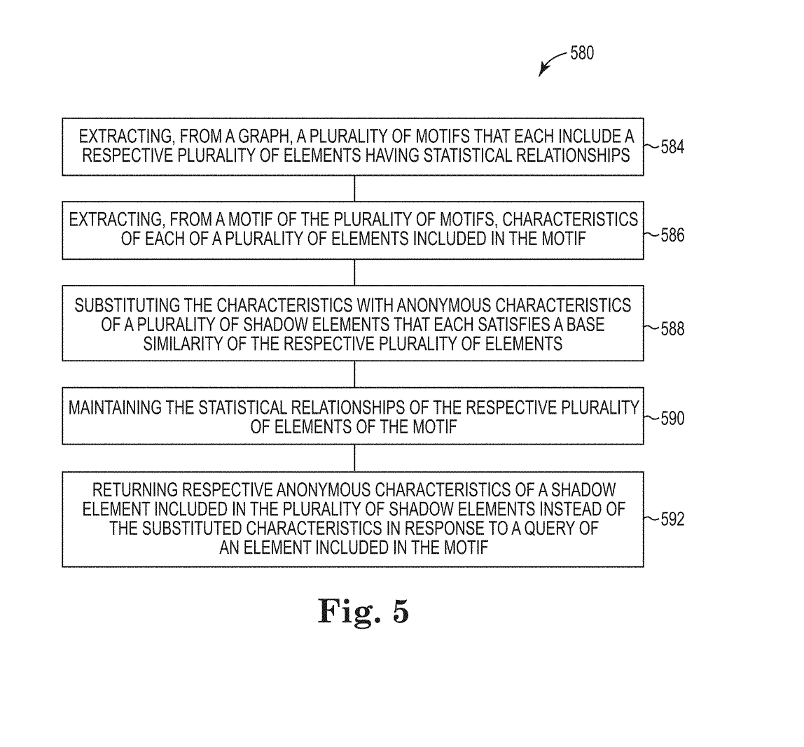

FIG. 5 illustrates a flow diagram of an example of a method for shadow elements according to the present disclosure. As shown at 584, in various examples, the method 580 can include extracting, from a graph, a plurality of motifs that can each include a respective plurality of elements having statistical relationships. That is a total number of shadow elements can vary from a motif to another motif including in a plurality of motifs. In some examples, a motif having a comparatively higher desired degree of anonymity can have a comparatively higher total number of a plurality of shadow elements (e.g., 200 shadow nodes) compared to another motif having a comparatively lower desired degree of anonymity with a comparatively lower total number of a plurality of shadow elements (e.g., 50 shadow nodes).

The method 580 can include, extracting, from a motif of the plurality of motifs, characteristics of each of a plurality of elements included in the motif, as shown at 586. Advantageously, extracting each of the plurality of elements (e.g., each of a plurality of nodes and each of a plurality of edges) in the motif can promote shadowing of each of the plurality of elements in the motif.

As shown at 588, the method 580 can include substituting the characteristics with anonymous characteristics of a plurality of shadow elements that each satisfies a base similarity of the respective plurality of elements. For example, substitution can occur without additional and/or removal of edges and/or nodes. In some examples, the method 580 can include substituting the characteristics occur without addition of elements to the graph. For instance, substitution of characteristics of a node occurs without addition of a node (e.g., without addition of a replacement node). That is, while shadowing an element with a shadow element promotes return of anonymous characteristic without return of characteristic(s) of the shadowed element. Put another way, a representation of the node itself (e.g., an visual representation such as a circle and/or identifying information associated with the node) remains in a graph but the node is capable of returning anonymous characteristics rather than the characteristics of the node in response to a query of the node, as described herein. Advantageously and in contrast to other approaches that utilize modification of a graph, substitution without modification of a graph promotes maintaining of statistical and/or spectral properties of a graph and elements (e.g., shadowed nodes) included in a graph.

For instance, as shown at 590, the method 580 can include maintaining the statistical relations of the respective plurality of elements of the motif, as shown at 590. In some examples, the method 580 can include maintaining a plurality of edges representing connections between the respective elements of the motif. The method 580 can include maintaining an anonymous identifier associated with the element. For example, a numerical anonymous identifier can be maintained before, during, and after substitution of the characteristics with anonymous characteristics.

The method 580 can, in some examples, include returning respective anonymous characteristics of a shadow element included in the plurality of shadow elements instead of the substituted characteristics in response to a query of an element included in the motif, as shown at 592. In some examples, returning can include displaying an indication of the respective anonymous characteristics of a shadow element. For example, an indication of respective anonymous characteristics of a shadow element can be visually displayed via a GUI of a support device and/or a client device. Displaying, for example, can include causing a display in response to receipt of a query of a graph, receipt of respective anonymous characteristics of a shadow element, and/or in various other manners to display information to promote shadow elements. An indication can be displayed and/or communicated to a support device, client device, and/or other device in a manner suitable to promote shadow elements.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 202 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to one or more of such elements and/or features.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

What is claimed:

1. A system, comprising a determine engine, a select engine, a substitute engine, and a return engine, wherein:
the determine engine determines a base similarity of an element included in a graph;
the select engine selects an anonymous characteristic of a shadow element satisfying the base similarity;
the substitute engine substitutes a characteristic of the element with the anonymous characteristic; and
the return engine returns the anonymous characteristic instead of the substituted characteristic in response to a query of the element included in the graph.

2. The system of claim 1, wherein the return engine, in response to another query of the element included in the graph, returns a respective anonymous characteristic of a different shadow element included in a plurality of shadow elements.

3. The system of claim 1, wherein statistical properties of the substituted characteristic in a particular motif are preserved through correlation of the substituted characteristic with the anonymous characteristic having the same statistical properties.

4. The system of claim 1, wherein the base similarity is a threshold based on at least one of a plurality of characteristics of the element included in the graph or a desired end use of the anonymous characteristic.

5. The system of claim 1, wherein the substitute engine substitutes a characteristic of a node included in the graph with an anonymous characteristic of a shadow node.

6. A non-transitory computer readable medium storing instructions executable by a processing resource to cause a device to:
determine a base similarity of a plurality of elements included in a motif extracted from a graph;
select anonymous characteristics of a shadow element of a plurality of shadow elements satisfying the base similarity;
substitute characteristics of each of the plurality of elements with the anonymous characteristics; and
return respective anonymous characteristics of the shadow element instead of the substituted characteristics in response to a query of an element of the plurality of elements included in the motif.

7. The medium of claim 6, wherein the selected anonymous characteristics include an anonymous characteristic of a synthetic element.

8. The medium of claim 6, including instructions to maintain statistical properties of the plurality of elements of the motif following substitution with the anonymous characteristics.

9. The medium of claim 8, including instructions to remove an isolated node from the graph.

10. The medium of claim 6, including instructions to substitute the respective characteristics without modification of the graph.

11. The medium of claim 6, wherein the instructions to select include instructions to select the anonymous characteristics of the shadow element that is included in a motif satisfying a base similarity.

12. A method, comprising:
extracting, from a graph, a plurality of motifs that each include a respective plurality of elements having statistical relationships;
extracting, from a motif of the plurality of motifs, characteristics of each of a plurality of elements included in the motif;
substituting the characteristics with anonymous characteristics of a plurality of shadow elements that each satisfies a base similarity of the respective plurality of elements;
maintaining the statistical relationships of the respective plurality of elements of the motif; and
returning respective anonymous characteristics of a shadow element included in the plurality of shadow elements instead of the substituted characteristics in response to a query of an element included in the motif.

13. The method of claim 12, wherein maintaining includes maintaining a plurality of edges representing connections between the respective plurality of elements of the motif.

14. The method of claim 12, wherein substituting the characteristics occurs without addition of elements to the graph.

15. The method of claim 12, wherein maintaining include maintaining an anonymous identifier associated with the element.
